(19) United States
(12) Patent Application Publication
(10) Pub. No.: US 2024/0103272 A1
(43) Pub. Date: Mar. 28, 2024

(54) Optical Systems Having Compact Display Modules

(71) Applicant: Apple Inc., Cupertino, CA (US)

(72) Inventors: Guolin Peng, Sunnyvale, CA (US); Vikrant Bhakta, Santa Clara, CA (US); Scott M. DeLapp, San Diego, CA (US); Hyungryul Choi, San Jose, CA (US); Di Hu, Mountain View, CA (US)

(21) Appl. No.: 18/254,351

(22) PCT Filed: Nov. 24, 2021
(86) PCT No.: PCT/US21/60733

§ 371 Date: May 24, 2023

Related U.S. Application Data
(60) Provisional application No. 63/119,510, filed on Nov. 30, 2020.

(51) Int. Cl. G02B 27/01

(52) U.S. Cl. CPC G02B 27/0172

(57) ABSTRACT

A display may include illumination optics (36), a spatial modulator (40) and a waveguide (26). The illumination optics may produce illumination that is modulated by the spatial modulator to produce image light. The waveguide may direct the image light towards an eye box. The illumination optics may include light sources (58) an X-plate (44), and at least one Fresnel lens (60) interposed between the light sources and the X-plate. The Fresnel lenses may minimize the size of the illumination optics while still exhibiting satisfactory optical performance. The spatial light modulator may include a reflective display panel (50) and a powered prism (48) with a reflective coating on a curved reflective surface. The powered prism may optimize f-number while minimizing the volume of the spatial light modulator. The collimating optics may include a diffractive optical element (56) that compensates for thermal effects and chromatic dispersion in the display.

This application claims priority to U.S. Provisional Patent Application No. 63/119,510, filed Nov. 30, 2020, which is hereby incorporated by reference herein in its entirety.

### BACKGROUND

This relates generally to optical systems and, more particularly, to optical systems for displays.

Electronic devices may include displays that present images to a user's eyes. For example, devices such as virtual reality and augmented reality headsets may include displays with optical elements that allow users to view the displays.

It can be challenging to design devices such as these. If care is not taken, the components used in displaying content may be unsightly and bulky, can consume excessive power, and may not exhibit desired levels of optical performance.

### SUMMARY

An electronic device such as a head-mounted device may have one or more near-eye displays that produce images for a user. The head-mounted device may be a pair of virtual reality glasses or may be an augmented reality headset that allows a viewer to view both computer-generated images and real-world objects in the viewer's surrounding environment.

The display may include a display module, a waveguide, and collimating optics. The display module may include a spatial light modulator and illumination optics. The illumination optics may produce illumination light. The illumination optics may include an X-plate and light sources that produce the illumination light. Fresnel lenses and/or spherical lenses may be optically interposed between the light sources and the X-plate to minimize the volume of the illumination optics while still exhibiting satisfactory optical performance.

The spatial light modulator may include a reflective display panel, a first prism, and a second prism mounted to the first prism. The second prism may be a powered prism having a curved reflective surface. A reflective coating may be layered over the curved reflective surface. The first prism may direct the illumination light towards the curved reflective surface of the second prism. The curved reflective surface may reflect the illumination light towards the reflective display panel through the first prism. The reflective display panel may generate image light by modulating image data onto the illumination light. The first prism may direct the image light towards the collimating optics. The second prism may match the f-number of the reflective display panel and may eliminate chromatic aberrations and volume that would otherwise be introduced by additional lenses.

The collimating optics may direct the image light towards the waveguide. The waveguide may direct the image light towards an eye box. The collimating optics may include a diffractive optical element or a Fresnel lens that serve to compensate for chromatic dispersion and thermal effects associated with other lenses in the display.

### BRIEF DESCRIPTION OF THE DRAWINGS

FIG. 1 is a diagram of an illustrative system having a display in accordance with some embodiments.

FIG. 2 is a top view of an illustrative optical system for a display having a display module that provides image light to a waveguide in accordance with some embodiments.

FIG. 3 is a top view of an illustrative display module having illumination optics with a combination of Fresnel lenses and spherical lenses in accordance with some embodiments.

FIG. 4 is a top view of an illustrative display module having illumination optics with Fresnel lenses in accordance with some embodiments.

### DETAILED DESCRIPTION

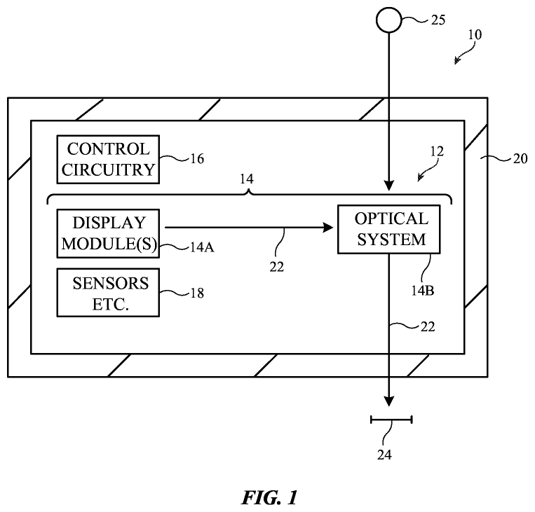

An illustrative system having a device with one or more near-eye display systems is shown in FIG. 1. System 10 may be a head-mounted device having one or more displays such as near-eye displays 14 mounted within support structure (housing) 20. Support structure 20 may have the shape of a pair of eyeglasses (e.g., supporting frames), may form a housing having a helmet shape, or may have other configurations to help in mounting and securing the components of near-eye displays 14 on the head or near the eye of a user. Near-eye displays 14 may include one or more display modules such as display modules 14A and one or more optical systems such as optical systems 14B. Display modules 14A may be mounted in a support structure such as support structure 20. Each display module 14A may emit light 22 that is redirected towards a user's eyes at eye box 24 using an associated one of optical systems 14B. Light 22 may sometimes be referred to herein as image light 22 (e.g., light that contains and/or represents something viewable such as a scene or object).

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code (instructions) may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.). If desired, components 18 may include gaze tracking sensors that gather gaze image data from a user's eye at eye box 24 to track the direction of the user's gaze in real time.

Display modules 14A (sometimes referred to herein as display engines 14A, light engines 14A, or projectors 14A) may include reflective displays (e.g., displays with a light source that produces illumination light that reflects off of a reflective display panel to produce image light such as liquid crystal on silicon (LCOS) displays, ferroelectric liquid crystal on silicon (fLCOS) displays, digital-micromirror device (DMD) displays, or other spatial light modulators), emissive displays (e.g., micro-light-emitting diode (uLED) displays, organic light-emitting diode (OLED) displays, laser-based displays, etc.), or displays of other types. Light sources in display modules 14A may include uLEDs, OLEDs, LEDs, lasers, combinations of these, or any other desired light-emitting components.

Optical systems 14B may form lenses that allow a viewer (see, e.g., a viewer's eyes at eye box 24) to view images on display(s) 14. There may be two optical systems 14B (e.g., for forming left and right lenses) associated with respective left and right eyes of the user. A single display 14 may produce images for both eyes or a pair of displays 14 may be used to display images. In configurations with multiple displays (e.g., left and right eye displays), the focal length and positions of the lenses formed by components in optical system 14B may be selected so that any gap present between the displays will not be visible to a user (e.g., so that the images of the left and right displays overlap or merge seamlessly).

If desired, optical system 14B may contain components (e.g., an optical combiner, etc.) to allow real-world image light from real-world images or objects 25 to be combined optically with virtual (computer-generated) images such as virtual images in image light 22. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement in which a camera captures real-world images of object 25 and this content is digitally merged with virtual content at optical system 14B).

System 10 may, if desired, include wireless circuitry and/or other circuitry to support communications with a computer or other external equipment (e.g., a computer that supplies display 14 with image content). During operation, control circuitry 16 may supply image content to display 14. The content may be remotely received (e.g., from a computer or other content source coupled to system 10) and/or may be generated by control circuitry 16 (e.g., text, other computer-generated content, etc.). The content that is supplied to display 14 by control circuitry 16 may be viewed by a viewer at eye box 24.

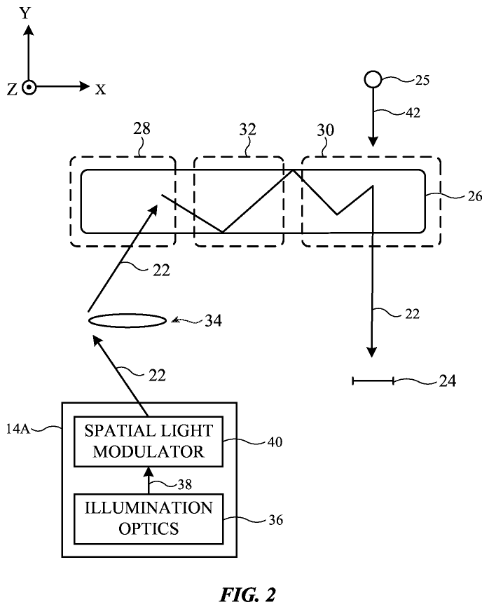

FIG. 2 is a top view of an illustrative display 14 that may be used in system 10 of FIG. 1. As shown in FIG. 2, near-eye display 14 may include one or more display modules such as display module(s) 14A and an optical system such as optical system 14B. Optical system 14B may include optical elements such as one or more waveguides 26. Waveguide 26 may include one or more stacked substrates (e.g., stacked planar and/or curved layers sometimes referred to herein as waveguide substrates) of optically transparent material such as plastic, polymer, glass, etc.

If desired, waveguide 26 may also include one or more layers of holographic recording media (sometimes referred to herein as holographic media, grating media, or diffraction grating media) on which one or more diffractive gratings are recorded (e.g., holographic phase gratings, sometimes referred to herein as holograms). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguide 26 may include holographic phase gratings such as volume holograms or thin-film holograms, meta-gratings, or any other desired diffractive grating structures. The diffractive gratings on waveguide 26 may also include surface relief gratings formed on one or more surfaces of the substrates in waveguides 26, gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles).

Optical system 14B may include collimating optics 34. Collimating optics 34 may sometimes be referred to herein as eyepiece 34, collimating lens 34, optics 34, or lens 34. Collimating optics 34 may include one or more lens elements that help direct image light 22 towards waveguide 26. Collimating optics 34 may be omitted if desired. If desired, display module(s) 14A may be mounted within support structure 20 of FIG. 1 while optical system 14B may be mounted between portions of support structure 20 (e.g., to form a lens that aligns with eye box 24). Other mounting arrangements may be used, if desired.

As shown in FIG. 2, display module 14A may generate image light 22 associated with image content to be displayed to (at) eye box 24. In the example of FIG. 2, display module 14A includes illumination optics 36 and spatial light modulator 40. Illumination optics 36 may produce illumination light 38 (sometimes referred to herein as illumination 38) and may illuminate spatial light modulator 40 using illumination light 38. Spatial light modulator 40 may modulate illumination light 38 (e.g., using image data) to produce image light 22 (e.g., image light that includes an image as identified by the image data). Spatial light modulator 40 may be a reflective spatial light modulator (e.g., a DMD modulator, an LCOS modulator, an fLCOS modulator, etc.) or a transmissive spatial light modulator (e.g., an LCD modulator). These examples are merely illustrative and, if desired, display module 14A may include an emissive display panel instead of a spatial light modulator. Examples in which spatial light modulator 40 is a reflective spatial light modulator are described herein as an example.

Image light 22 may be collimated using collimating optics 34. Optical system 14B may be used to present image light 22 output from display module 14A to eye box 24. Optical system 14B may include one or more optical couplers such as input coupler 28, cross-coupler 32, and output coupler 30. In the example of FIG. 2, input coupler 28, cross-coupler 32, and output coupler 30 are formed at or on waveguide 26. Input coupler 28, cross-coupler 32, and/or output coupler 30 may be completely embedded within the substrate layers of waveguide 26, may be partially embedded within the substrate layers of waveguide 26, may be mounted to waveguide 26 (e.g., mounted to an exterior surface of waveguide 26), etc.

The example of FIG. 2 is merely illustrative. One or more of these couplers (e.g., cross-coupler 32) may be omitted. Optical system 14B may include multiple waveguides that are laterally and/or vertically stacked with respect to each other. Each waveguide may include one, two, all, or none of couplers 28, 32, and 30. Waveguide 26 may be at least partially curved or bent if desired.

Waveguide 26 may guide image light 22 down its length via total internal reflection. Input coupler 28 may be configured to couple image light 22 from display module(s) 14A into waveguide 26, whereas output coupler 30 may be configured to couple image light 22 from within waveguide 26 to the exterior of waveguide 26 and towards eye box 24. Input coupler 28 may include an input coupling prism if desired. As an example, display module(s) 14A may emit image light 22 in the +Y direction towards optical system 14B. When image light 22 strikes input coupler 28, input coupler 28 may redirect image light 22 so that the light propagates within waveguide 26 via total internal reflection towards output coupler 30 (e.g., in the +X direction). When image light 22 strikes output coupler 30, output coupler 30 may redirect image light 22 out of waveguide 26 towards eye box 24 (e.g., back in the −Y direction). In scenarios where cross-coupler 32 is formed at waveguide 26, cross-coupler 32 may redirect image light 22 in one or more directions as it propagates down the length of waveguide 26, for example.

Input coupler 28, cross-coupler 32, and/or output coupler 30 may be based on reflective and refractive optics or may be based on holographic (e.g., diffractive) optics. In arrangements where couplers 28, 30, and 32 are formed from reflective and refractive optics, couplers 28, 30, and 32 may include one or more reflectors (e.g., an array of micromirrors, partial mirrors, louvered mirrors, or other reflectors). In arrangements where couplers 28, 30, and 32 are based on holographic optics, couplers 28, 30, and 32 may include diffractive gratings (e.g., volume holograms, surface relief gratings, etc.). Any desired combination of holographic and reflective optics may be used to form couplers 28, 30, and 32.

In one suitable arrangement that is sometimes described herein as an example, output coupler 30 is formed from diffractive gratings or micromirrors embedded within waveguide 26 (e.g., volume holograms recorded on a grating medium stacked between transparent polymer waveguide substrates, an array of micromirrors embedded in a polymer layer interposed between transparent polymer waveguide substrates, etc.), whereas input coupler 28 includes a prism mounted to an exterior surface of waveguide 26 (e.g., an exterior surface defined by a waveguide substrate that contacts the grating medium or the polymer layer used to form output coupler 30) or one or more layers of diffractive grating structures.

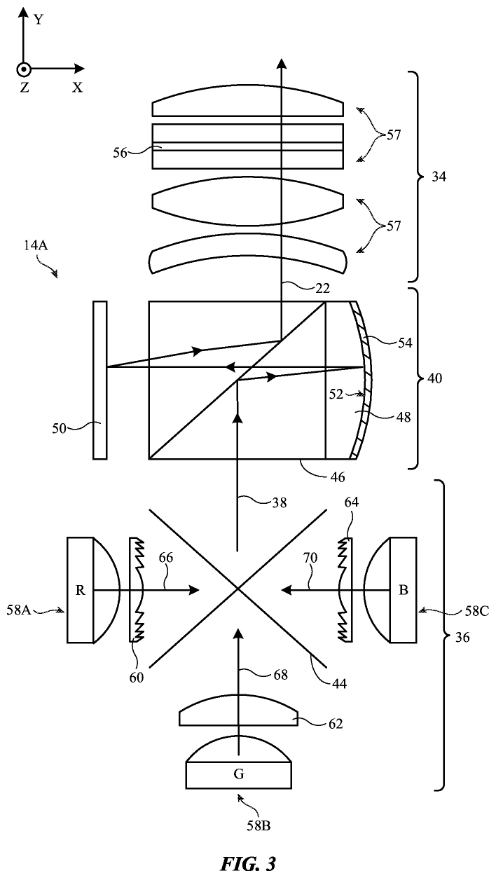

FIG. 3 is a top view of display module 14A in an example where spatial light modulator 40 is a reflective spatial light modulator such as an fLCOS or LCOS spatial light modulator. As shown in FIG. 3, display module 14A may include illumination optics 36 that provide illumination light 38 to spatial light modulator 40. Spatial light modulator 40 may modulate images onto illumination light 38 to produce image light 22. Image light 22 may be directed towards input coupler 28 of waveguide 26 (FIG. 2) by collimating optics 34. Collimating optics 34 may include one or more lens elements 57. Each lens element 57 may have one or more concave surfaces, convex surfaces, spherical surfaces, aspherical surfaces, freeform curved surfaces, etc. One or more lens elements 57 may impart optical power to image light 22 if desired.

Illumination optics 36 may include one or more light sources 58. Light sources 58 may include LEDs, OLEDs, uLEDs, lasers, etc. An example in which light sources 58 are LED light sources is described herein as an example. Each light source 58 may emit illumination light of the same wavelength band (color). For example, as shown in FIG. 3, illumination optics 36 may include a first light source 58A that emits illumination light of a first color (e.g., red (R) illumination light), as shown by arrow 66, a second light source 58B that emits illumination light of a second color (e.g., green (G) illumination light), as shown by arrow 68, and a third light source 58C that emits illumination light of a third color (e.g., blue (B) illumination light), as shown by arrow 70. Each light source 58 may include a light emitter (e.g., an LED die or other light-emitting structure) and one or more lenses and/or microlenses that help to direct the illumination light in a desired direction. This example is merely illustrative. In general, each light source 58 may emit light of any desired color. Light source 58A may be replaced with an array of light sources, light source 58B may be replaced with an array of light sources, and/or light source 58C may be replaced with an array of light sources if desired. Illumination optics 36 may include more than three or fewer than three light sources 58 if desired.

Each light source 58 in illumination optics 36 may emit a respective portion of illumination light 38, as shown by arrows 66, 68, and 70. Illumination optics 36 may include partially reflective structures such as X-plate 44 that combines the light emitted by each of the light sources 58 in illumination optics 36 into illumination light 38 (e.g., illumination light 38 may include red, green, and blue light emitted by the light sources 58A, 58B, and 58C). X-plate 44 may include a pair of partially reflective plates that reflect light of some wavelengths while transmitting light of other wavelengths, for example. If desired, X-plate 44 may be provided with optical wedges that help to support X-plate 44 (not shown in FIG. 3 for the sake of clarity). X-plate 44 may, for example, be formed from coatings or layers on surfaces of the optical wedges. In scenarios where optical wedges are provided in illumination optics 36 for supporting X-plate 44, the X-plate and wedges may sometimes be referred to collectively as a prism (e.g., prism 44).

Illumination light 38 may include the illumination light generated by light source 58A (e.g., red light), the illumination light generated by light source 58B (e.g., green light), and/or the illumination light generated by light source 58C (e.g., blue light). X-plate 44 may provide illumination light 38 to spatial light modulator 40. Lens elements (not shown in FIG. 3 for the sake of clarity) may be used to help direct illumination light 38 from illumination optics 36 to spatial light modulator 40 if desired.

In order to help minimize the volume of illumination optics 36 and thus the overall volume of display module 14A while still exhibiting satisfactory optical performance, Fresnel lenses may be optically interposed between one or more of the light sources 58 and X-plate 44 in illumination optics 36. For example, as shown in FIG. 3, a Fresnel lens such as Fresnel lens 60 may be optically interposed between light source 58A and X-plate 44. The illumination light emitted by light source 58A, as shown by arrow 66, may pass through Fresnel lens 60 prior to passing to X-plate 44. Fresnel lens 60 may help to direct the illumination light associated with arrow 66. Similarly, a Fresnel lens such as Fresnel lens 64 may be optically interposed between light source 58C and X-plate 44. The illumination light emitted by light source 58C, as shown by arrow 70, may pass through Fresnel lens 64 prior to passing to X-plate 44. Fresnel lens 64 may help to direct the illumination light associated with arrow 70. If desired, an additional Fresnel lens may be optically interposed between light source 58B and X-plate 44. Other types of lenses (e.g., non-Fresnel lenses) may additionally or alternatively be interposed between one or more light source 58 and X-plate 44.

In one suitable arrangement that is described herein as an example (e.g., in scenarios where spatial light modulator 40 includes an fLCOS panel), a spherical lens such as spherical lens 62 may be optically interposed between light source 58B and X-plate 44. This is merely illustrative and, in general, any combination of Fresnel and non-Fresnel lenses may be optically interposed between any combination of the light sources 58 in illumination optics 36 and X-plate 44. One or more of the Fresnel lenses in illumination optics 36 may be a fixed Fresnel lens having one or more geometric surfaces (e.g., surfaces having concentric ridges and peaks) that configure the lens to be a Fresnel lens and/or having a fixed refractive index profile that configures the lens to be a Fresnel lens. If desired, one or more of the Fresnel lenses in illumination optics 36 may be an electrically adjustable lens having an electrically adjustable refractive index profile that can be set so that the lens effectively forms a Fresnel lens at a given time. Additional optical components (not shown in FIG. 3 for the sake of clarity) such as lenses, microlenses, polarizers, or other optical components may be optically interposed at any desired locations between light sources 58 and spatial light modulator 40 if desired. The Fresnel lenses in illumination optics 36 may serve to optimize angular space uniformity for the illumination light while also minimizing the volume of illumination optics 36, for example.

Spatial light modulator 40 may include prism 46 and a reflective display panel such as display panel 50. Display panel 50 may be a DMD panel, an LCOS panel, an fLCOS panel, or other reflective display panel. Prism 46 may direct illumination light 38 onto display panel 50 (e.g., different pixels on display panel 50). Control circuitry 16 (FIG. 1) may control display panel 50 to selectively reflect illumination light 38 at each pixel location to produce image light 22 (e.g., image light having an image as modulated onto the illumination light by display panel 50). Prism 46 may direct image light 22 toward collimating optics 34.

In order to further optimize the performance of display module 14A while minimizing volume, spatial light modulator 40 may include a powered prism such as powered prism 48. Powered prism 48 may be mounted to prism 46 or may be spaced apart from prism 46. Illumination light 38 may pass through prism 46 into powered prism 48 and may reflect off of reflective surface 52 of powered prism 48 towards display panel 50. Reflective surface 52 may be curved to impart an optical power to illumination light 38 while also directing the illumination light towards display panel 50. Reflective surface 52 may have a spherical curvature, an aspherical curvature, a freeform curvature, or any other desired curvature. If desired, an optional reflective layer such as reflective coating 54 may be layered onto reflective surface 52 to help reflect illumination light 38 towards display panel 50. Reflective coating 54 may be uniformly reflective across all or substantially all visible wavelengths. Powered prism 48 (e.g., reflective surface 52 and/or reflective coating 54) may, for example, add optical power to illumination light 38 to match the f-number of display panel 50 while occupying less volume and introducing less chromatic aberration relative to scenarios were separate lenses are used.

If desired, collimating optics 34 may include a diffractive optical element such as diffractive optical element (DOE) 56. DOE 56 may be layered onto a surface of one or more of the lens elements 57 in collimating optics 34 or may be separated from the other lens elements 57 in collimating optics 34. DOE 56 may include diffractive grating structures (e.g., one or more thin film holograms, surface relief gratings, thick medium holograms, volume holograms, meta gratings, etc.) that serve to change the phase of image light 22 and/or that serve to increase the efficiency of the image light 22 transmitted by collimating optics 34. DOE 56 may, for example, be configured to compensate for chromatic dispersion introduced by other lens elements in the display (e.g., DOE 56 may have a negative Abbe number that counteracts the positive Abbe number of other lenses in the display) and/or thermalization effects (e.g., thermal MTF shifts) associated with the other optics in the display. DOE 56 may exhibit relatively high and uniform efficiency across the visible spectrum, for example. In another suitable arrangement, DOE 56 may be replaced with a Fresnel lens that also compensates for chromatic dispersion and/or thermal MTF shifts while exhibiting high efficiency across the visible spectrum.

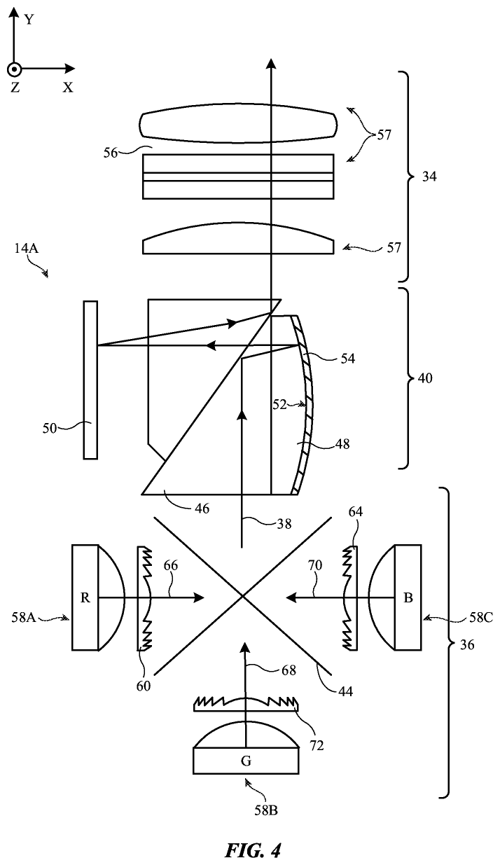

The example of FIG. 3 in which illumination optics 36 include a spherical lens 62 between light source 58B and X-plate 44 is merely illustrative. In another suitable arrangement, a Fresnel lens may be optically interposed between light source 58B and X-plate 44, as shown by Fresnel lens 72 in FIG. 4 (e.g., the illumination light produced by each light source 58 may pass through a respective Fresnel lens prior to arriving at X-plate 44). Fresnel lens 72 may be used instead of spherical lens 62 of FIG. 3 in examples where display panel 50 is a DMD panel, as one example. The examples of FIGS. 3 and 4 are merely illustrative. Display panel 50 may be any desired type of display panel. If desired, DOE 56 and/or powered prism 48 may be omitted. If desired, Fresnel lenses 60, 64, and 72 and/or spherical lens 62 (FIG. 3) may be omitted (e.g., the display may include any desired combination of DOE 56, powered prism 48, and additional lenses such as Fresnel lenses or non-Fresnel lenses between light sources 58 and X-plate 44).

In accordance with an embodiment, a display system is provided that includes a spatial light modulator configured to produce image light by modulating illumination light using image data; a partially reflective structure configured to direct the illumination light towards the spatial light modulator; a light source configured to emit a portion of the illumination light; a Fresnel lens optically interposed between the light source and the partially reflective structure; and a waveguide configured to direct the image light.

In accordance with another embodiment, the spatial light modulator includes a reflective display panel.

In accordance with another embodiment, the spatial light modulator includes a powered prism configured to direct the illumination light towards the reflective display panel.

In accordance with another embodiment, the powered prism has a curved reflective surface that is configured to reflect the illumination light.

In accordance with another embodiment, the spatial light modulator includes a reflective coating on the curved reflective surface of the powered prism.

In accordance with another embodiment, the display system includes collimating optics configured to direct the image light towards the waveguide, the spatial light modulator includes a prism configured to direct the illumination light towards the reflective display panel and configured to direct the image light towards the collimating optics, the powered prism is mounted to the prism.

In accordance with another embodiment, the collimating optics include a diffractive optical element configured to diffract the image light.

In accordance with another embodiment, the collimating optics include an additional Fresnel lens configured to transmit the image light.

In accordance with another embodiment, the reflective display panel includes a ferroelectric liquid crystal on silicon (fLCOS) display panel.

In accordance with another embodiment, the display system includes an additional light source configured to emit an additional portion of the illumination light; and a spherical lens optically interposed between the additional light source and the partially reflective structure, the portion of the illumination light includes red light and the additional portion of the illumination light includes green light.

In accordance with another embodiment, the reflective display panel includes a digital micromirror device (DMD) display panel.

In accordance with another embodiment, the display system includes an additional light source configured to emit an additional portion of the illumination light; and an additional Fresnel lens optically interposed between the additional light source and the partially reflective structure, the additional portion of the illumination light includes green light.

In accordance with another embodiment, the reflective display panel includes a liquid crystal on silicon (LCOS) display panel.

In accordance with an embodiment, a display system is provided that includes illumination optics configured to produce illumination light; a reflective display panel configured to produce image light by modulating illumination light using image data; a waveguide configured to direct the image light; collimating optics configured to direct the image light towards the waveguide; a first prism having a curved reflective surface configured to reflect the illumination light towards the reflective display panel; and a second prism mounted to the first prism, the second prism is configured to direct the illumination light from the illumination optics towards the first prism, the second prism is configured to transmit the illumination light reflected by the curved reflective surface towards the reflective display panel, and the second prism is configured to direct the image light produced by the reflective display panel towards the collimating optics.

In accordance with another embodiment, the display includes a reflective coating on the curved reflective surface.

In accordance with another embodiment, the collimating optics include a diffractive optical element configured to diffract the image light.

In accordance with another embodiment, the collimating optics include a Fresnel lens configured to transmit the image light.

In accordance with another embodiment, the reflective display panel includes a display panel selected from the group consisting of: a liquid crystal on silicon (LCOS) display panel, a ferroelectric liquid crystal on silicon (fLCOS) display panel, and a digital micromirror device (DMD) display panel.

In accordance with an embodiment, a display system is provided that includes a spatial light modulator configured to produce image light by modulating illumination light using image data; a waveguide configured to direct the image light; and illumination optics configured to produce the illumination light, the illumination optics include a first light source configured to emit a first portion of the illumination light, the first portion of the illumination light includes light of a first wavelength range, a second light source configured to emit a second portion of the illumination light, the second portion of the illumination light includes light of a second wavelength range that is different from the first wavelength range, a partially reflective structure configured to produce the illumination light by combining at least the first and second portions of the illumination light, a first Fresnel lens configured to transmit the first portion of the illumination light towards the partially reflective structure, and a second Fresnel lens configured to transmit the second portion of the illumination light towards the partially reflective structure.

In accordance with another embodiment, the display system includes collimating optics configured to direct the image light towards the waveguide, the collimating optics includes a diffractive optical element configured to diffract the image light.

The foregoing is merely illustrative and various modifications can be made to the described embodiments. The foregoing embodiments may be implemented individually or in any combination.

What is claimed is:

1. A display system comprising:
a spatial light modulator configured to produce image light by modulating illumination light using image data;
a partially reflective structure configured to direct the illumination light towards the spatial light modulator;
a light source configured to emit a portion of the illumination light;
a Fresnel lens optically interposed between the light source and the partially reflective structure; and
a waveguide configured to direct the image light.

2. The display system of claim 1, wherein the spatial light modulator comprises a reflective display panel.

3. The display system of claim 2, wherein the spatial light modulator comprises a powered prism configured to direct the illumination light towards the reflective display panel.

4. The display system of claim 3, wherein the powered prism has a curved reflective surface that is configured to reflect the illumination light.

5. The display system of claim 4, wherein the spatial light modulator comprises:
a reflective coating on the curved reflective surface of the powered prism.

6. The display system of claim 5, further comprising:
collimating optics configured to direct the image light towards the waveguide, the spatial light modulator further comprising:
a prism configured to direct the illumination light towards the reflective display panel and configured to direct the image light towards the collimating optics, wherein the powered prism is mounted to the prism.

7. The display system of claim 6, wherein the collimating optics comprise a diffractive optical element configured to diffract the image light.

8. The display system of claim 6, wherein the collimating optics comprise an additional Fresnel lens configured to transmit the image light.

9. The display system of claim 2, wherein the reflective display panel comprises a ferroelectric liquid crystal on silicon (fLCOS) display panel.

10. The display system of claim 9, further comprising:
an additional light source configured to emit an additional portion of the illumination light; and
a spherical lens optically interposed between the additional light source and the partially reflective structure, wherein the portion of the illumination light comprises red light and wherein the additional portion of the illumination light comprises green light.

11. The display system of claim 2, wherein the reflective display panel comprises a digital micromirror device (DMD) display panel.

12. The display system of claim 11, further comprising:
an additional light source configured to emit an additional portion of the illumination light; and
an additional Fresnel lens optically interposed between the additional light source and the partially reflective structure, wherein the additional portion of the illumination light comprises green light.

13. The display system of claim 2, wherein the reflective display panel comprises a liquid crystal on silicon (LCOS) display panel.

14. A display system comprising:
illumination optics configured to produce illumination light;
a reflective display panel configured to produce image light by modulating illumination light using image data;
a waveguide configured to direct the image light;
collimating optics configured to direct the image light towards the waveguide;
a first prism having a curved reflective surface configured to reflect the illumination light towards the reflective display panel; and
a second prism mounted to the first prism, wherein the second prism is configured to direct the illumination light from the illumination optics towards the first prism, wherein the second prism is configured to transmit the illumination light reflected by the curved reflective surface towards the reflective display panel, and wherein the second prism is configured to direct the image light produced by the reflective display panel towards the collimating optics.

15. The display system of claim 14, further comprising a reflective coating on the curved reflective surface.

16. The display system of claim 15, wherein the collimating optics comprise a diffractive optical element configured to diffract the image light.

17. The display system of claim 15, wherein the collimating optics comprise a Fresnel lens configured to transmit the image light.

18. The display system of claim 14, wherein the reflective display panel comprises a display panel selected from the group consisting of: a liquid crystal on silicon (LCOS) display panel, a ferroelectric liquid crystal on silicon (fLCOS) display panel, and a digital micromirror device (DMD) display panel.

19. A display system comprising:
a spatial light modulator configured to produce image light by modulating illumination light using image data;
a waveguide configured to direct the image light; and
illumination optics configured to produce the illumination light, wherein the illumination optics comprise:
a first light source configured to emit a first portion of the illumination light, the first portion of the illumination light comprising light of a first wavelength range,
a second light source configured to emit a second portion of the illumination light, the second portion of the illumination light comprising light of a second wavelength range that is different from the first wavelength range,
a partially reflective structure configured to produce the illumination light by combining at least the first and second portions of the illumination light,
a first Fresnel lens configured to transmit the first portion of the illumination light towards the partially reflective structure, and
a second Fresnel lens configured to transmit the second portion of the illumination light towards the partially reflective structure.

20. The display system of claim 19, further comprising:
collimating optics configured to direct the image light towards the waveguide, wherein the collimating optics comprises a diffractive optical element configured to diffract the image light.
